(19) United States
(12) Patent Application Publication
(10) Pub. No.: US 2025/0211985 A1
(43) Pub. Date: Jun. 26, 2025

(54) SYSTEM AND METHOD FOR AUTHENTICATING AND AUTHORIZING A CALLING PARTY IN A WIRELESS COMMUNICATION SYSTEM

(71) Applicant: Samsung Electronics Co., Ltd., Gyeonggi-do (KR)

(72) Inventor: Ashok Kumar NAYAK, Bangalore (IN)

(21) Appl. No.: 18/843,580

(22) PCT Filed: Mar. 3, 2023
(86) PCT No.: PCT/KR2023/002969

§ 371 Date: Sep. 3, 2024

(30) Foreign Application Priority Data
Mar. 4, 2022 (IN) 202241011757
Jan. 30, 2023 (IN) 202241011757

(51) Int. Cl. H04W 12/06; H04L 65/1016; H04W 8/04; H04W 76/14

(52) U.S. Cl. CPC H04W 12/06; H04L 65/1016; H04W 8/04; H04W 76/14

(57) ABSTRACT

The disclosure relates to a 5G or 6G communication system for supporting a higher data transmission rate. Specifically, the disclosure related to a system and method for authenticating and authorizing a calling party by an IP Multimedia Subsystem (IMS) network. In particular, the present disclosure provides a unique mechanism implemented at the HSS for providing parameter provisioning service by exposing related application programming interface (API) to the third party for creating the group data information with all the necessary details like list of IMPUs for which authentication and authorization is needed to use a first node identities assigned by the first node. The group data information is further utilized by IMS originating network for invoking a signing server for performing secondary A&A for the calling party. The method further includes invoking a verification sever for validation of the call invite request by IMS terminating network based on the presence of identity header added by signing server. Further, based on a receipt of a validation status response from the verification server, the call invite is forwarded to the called party for the establishment of the call between the calling party and the called party. Thus, the disclosed mechanism ensures that the called party receives a call from the intended user.

### TECHNICAL FIELD

The present disclosure relates to a system and method for authenticating and authorizing a calling party by an IP Multimedia Subsystem (IMS) network in a wireless communication system. In particular, the present disclosure relates to a procedure for authenticating and authorizing of calling party when using third party specific identity in the IMS network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure related to wireless communication systems and, more specifically, the present disclosure relates to a system and method for authenticating and authorizing a calling party by an IP Multimedia Subsystem (IMS) network in a wireless communication system.

### Solution to Problem

In an implementation, the present subject matter provides a system and method for authenticating and authorizing a calling party by an IP Multimedia Subsystem (IMS) network in a wireless communication system. The method includes registering a plurality of calling parties of a first node to an IMS originating network and then sending an invite by the calling parties of the first node to an IMS server of the originating network for establishing a call with a called party. Now, upon receiving an invite from the calling party for establishing a call with a called party, the method includes authorizing the calling party to use a first node identities and determining by an IMS originating network, whether to invoke at least one signing server for performing secondary authenticating and authorizing (A&A) for the calling parties based on the authorization. Thereafter, the method includes authenticating, by the at least one signing server, the received call invite request of the calling parties upon determination of invoking the at least one signing server and adding, by the at least one signing server, an identity header to the call invite request and sending the call invite request to the IMS originating network. The method further includes forwarding by the IMS originating network the call invite request to an IMS terminating network. Thereafter, the method includes invoking, by an IMS terminating network, a verification server for validation of the call invite request based on a presence of the identity header that was added in the call invite request, by the at least one signing server. Now based on a receipt of a validation status response from the verification server, forwarding the call invite to the called party for the establishment of the call between the calling parties and the called party.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 illustrates a flow chart depicting a method for authenticating and authorizing a calling party by an IP Multimedia Subsystem (IMS) network, according to an embodiment of the present disclosure.

FIG. 2 illustrates an operational flow diagram depicting a process 200 for authenticating and authorizing a calling party by an IP Multimedia Subsystem (IMS) network, according to an embodiment of the present disclosure.

FIG. 3A illustrates a system architecture of UE, according to an embodiment of the present disclosure.

FIG. 3B illustrates a system architecture of O-SCSCF/Signing Server/T-SCSCF/Verification Server/Third party/AF/HSS, according to an embodiment of the present disclosure.

### BEST MODE FOR CARRYING OUT THE INVENTION

Accordingly, the embodiment herein is to provide a method for authenticating and authorizing (A&A) a calling party by an IP Multimedia Subsystem (IMS) network in a wireless communication system. The method includes registering a plurality of calling parties of a first node to an IMS originating network, sending an invite by the calling party of the first node to an IMS server of the originating network for establishing a call with a called party, upon receiving an invite from a calling party for establishing a call with a called party, authorizing the calling party to use a first node identities and determining by an IMS originating network, whether to invoke at least one signing server for performing secondary A&A for the calling party based on the authorization, authenticating, by the at least one signing server, the received call invite request of the calling party upon determination of invoking the at least one signing server, adding, by the at least one signing server, an identity header to the call invite request and sending the call invite request to the IMS originating network, forwarding by the IMS originating network the call invite request to an IMS terminating network, invoking, by an IMS terminating network, a verification server for validation of the call invite request based on a presence of the identity header that was added in the call invite request, by the at least one signing server, and based on a receipt of a validation status response from the verification server, forwarding the call invite to the called party for the establishment of the call between the calling party and the called party.

In an embodiment, a Home Subscriber Server (HSS) provides a parameter provisioning service by exposing related application programming interface (API) to the first node for creating a group data information related to a plurality of calling parties of the first node, wherein the group data information includes a list of IMS Public User Identity (IMPUs) that is assigned by the first node for each of the plurality of calling parties, secondary authentication and authorization (A&A) enable or disable information and a signing server address.

In an embodiment, the authorization of the calling party to use the first node identities and the determination by the IMS server of the originating network, whether to invoke at least one signing server for performing secondary A&A for the calling party is based on the secondary A&A enable or disable information present in the group data information and an IMPU information associated with the calling party included in the list of IMPU.

In an embodiment, the creation of the group data information further includes assigning, by the first node, the IMPU's, for each of a plurality of subscribers, as the first node identities, generating, by the first node, a list of IMPUs including the IMPU's that is assigned for each of the plurality of subscribers, creating, by the first node, the group data information including the plurality of parameters that further includes IMS private identification (IMPI) of the plurality of calling parties, a signing server address corresponding to each of the plurality of calling parties that authenticates each of the plurality of calling parties, enable or disable information of the secondary authentication and authorization (A&A) enable or disable information, and an identity information of the first node, and sending, by the first node, the created group data information to the HSS, wherein the authorization of the calling party is based on a presence of the IMPU of the calling party in the group data information.

In an embodiment, the method further includes providing a provision, by the HSS, in the parameter provisioning service to modify, query or delete the group data information, thereby providing a control to the first node for modifying and deleting the group data information.

In an embodiment, the first node directly uses the parameter provisioning service if the first node is a trusted Application Function (AF)

In an embodiment, the first node uses the parameter provisioning service through a Network Exposure Function (NEF) if the first node is an untrusted Application Function (AF).

In an embodiment, upon receiving the call invite, the method includes downloading, by the IMS server of the originating network, the IMPU information associated with a first subscriber from the HSS, determining, by the IMS server of the originating network, whether the IMPU information, associated with the first subscriber, is present in the list of IMPUs included in the group data information. Further, the at least one signing server is invoked based on a result of the determination that the first subscriber's IMPU is present in the list of IMPUs and the secondary authentication and authorization (A&A) is enabled for the IMPU. Further, the at least one signing server is invoked by invoking the signing server address corresponding to the first subscriber's IMPU that is included in the group data information.

In an embodiment, the identity header includes attestation information, and the attestation information includes a verification certificate key.

In an embodiment, the method further includes verifying, by the verification server, the verification certificate key, validating, by the verification server, the call request based on the verification, and sending, by the verification server, a validation status response, to the IMS server of the originating network, indicating a successful status or an unsuccessful status, the validation status response indicating the successful status represents that the received call request invite is from the authorized calling party.

In an embodiment, the method further includes determining, by the IMS server of the originating network, whether the called party belongs to same AF based on the group data information, and forwarding, by the IMS server of the originating network, the call invite directly from the calling party to the called party for the establishment of the call between the calling party and the called party and thereby skipping the invocation of the at least one signing server for enabling secondary A&A for the first user subscriber, wherein the call is forwarded based on the determination that the called party belongs to same AF.

In an embodiment, the method further includes determining, by the IMS server of the originating network, whether the calling party belongs to a same operator of the called party, and forwarding the call invite directly from the calling party to the called party for the establishment of the call between the calling party and the called party thereby skipping the invocation of the at least one signing server for enabling secondary A&A for the calling party, wherein the call is forwarded based on the determination that the calling party and the called party belong to the same operator.

In an embodiment, the registration to the IMS originating network is based on IMS subscription information.

Accordingly, the embodiment herein is to provide an IP Multimedia Subsystem (IMS) network entity for authenticating and authorizing a calling party in a wireless communication system. The IMS network entity includes a serving call session control function (S-CSCF) configured to register a plurality of a calling party of a first node to an IMS originating network. Further, the IMS network entity includes a calling party is configured to send an invite to the IMS originating server for establishing a call with a called party. Further, the IMS network entity includes an IMS originating network configured to upon receiving an invite from the calling party for establishing a call with a called party, authorize the calling party to use a first node identities and determining whether to invoke at least one signing server for performing secondary A&A for the calling party based on the authorization. Further, the IMS network entity includes at least one signing server configured to authenticating the received call invite request of the calling party upon determination of invoking the at least one signing server and adding an identity header to the call invite request and sending the call invite request to the IMS originating network. Further, the IMS network entity includes an IMS terminating network configured to receive the call invite request that is forwarded by the IMS originating network, invoke a verification server for validation of the call invite request based on a presence of the identity header that was added in the call invite request, by the at least one signing server, and forward, based on a receipt of a validation status response from the verification server, the call invite to the called party for the establishment of the call between the calling party and the called party.

Accordingly, the embodiment herein is to a method performed by a calling party by an IP Multimedia Subsystem (IMS) network in a wireless communication system. The method includes providing, by a Home Subscriber Server (HSS), parameter provisioning service by exposing related application programming interface API to a first node for creating a group data information related to a plurality of the calling party, receiving, by the HSS, the group data information including a plurality of parameters including at least one of a list of IMS Public User Identity (IMPUs) that is assigned by the first node for each of the plurality of calling parties, secondary authentication and authorization (A&A) enable or disable information and a signing server address, based on the received group data information, registering, by the HSS, implicitly each of the plurality of calling parties as an implicit registration set (IRS) subscriber or directly as an individual calling party, receiving, by an IMS originating network, a call invite request from a calling party for establishing a call with a called party, upon receiving the call invite from the calling party, determining, by the IMS originating network, authorizing the calling party to use a first node identities and determining whether to invoke at least one signing server for performing secondary A&A for the calling party based on the secondary A&A enable or disable information present in the group data information and a presence of IMPU information associated with the calling party in the group data information, authenticating, by the at least one signing server, the received call invite request of the calling party upon determination of invoking the at least one signing server, adding, by the at least one signing server, an identity header that includes attestation information to the call invite request, invoking, by an IMS terminating network, a verification server for validation of the call invite request based on a presence of the identity header added in the call invite request, and based on a receipt of a validation status response from the verification server, forwarding the call invite to the called party for the establishment of the call between the calling party and the called party.

Accordingly, the embodiment herein is to An IP Multimedia Subsystem (IMS) network entity for authenticating and authorizing a calling party in a wireless communication system. The IMS network entity includes a Home Subscriber Server (HSS) configured to provide parameter provisioning service by exposing related application programming interface API to a first node (third party/AF) for creating a group data information related to a plurality of the calling party, receive the group data information including a plurality of parameters including at least one of a list of IMS Public User Identity (IMPUs) that is assigned by the first node for each of the plurality of calling parties, secondary authentication and authorization (A&A) enable or disable information and a signing server address, and based on the received group data information, register implicitly each of the plurality of calling parties as an implicit registration set (IRS) subscriber or directly as an individual calling party. Further, the IMS network entity includes an IMS originating network configured to receive a call invite request from a calling party for establishing a call with a called party, and upon receiving the call invite from the calling party, authorize the calling party to use a first node identities and determine whether to invoke at least one signing server for performing secondary A&A for the calling party based on the secondary A&A enable or disable information present in the group data information and a presence of IMPU information associated with the calling party in the group data information. Further, the IMS network entity includes at least one signing server configured to authenticate the received call invite request of the calling party upon determination of invoking the at least one signing server and add an identity header that includes attestation information to the call invite request. Further, the IMS network entity includes an IMS terminating network configured to invoke a verification server for validation of the call invite request based on a presence of the identity header added in the call invite request and based on a receipt of a validation status response from the verification server, forwarding the call invite to the called party for the establishment of the call between the calling party and the called party.

### Mode for the Invention

Since a few years ago, most organizations have started using Multimedia Telephony (MMTEL) over IMS services not just for making voice calls, but also for other services, such as not limited to online meetings or Augmented Reality (AR)/Virtual Reality (VR) calls. Several primary functions organizations have started using MMTEL services for internal communication, talking with prospects (sales call), contacting current customers and clients, customer support, and contact centre (or call centre) activities. While the customers consider that the MMTEL services offer attractive features to their business. The customers also point out some practical issues as follows:
Internal communication-MMTEL for internal communication can include, but is not limited to voice calling, hosting online meetings, messaging co-workers, and team collaboration features like screen sharing. It could be challenging to manage the individual subscriptions for employees, especially considering employees may leave or join the companies (international companies) or relocate to different countries.
Communication with current or potential customers-while MMTEL offers attractive pre-call, in-call, and post-call features, the biggest issue for most of the businesses is that calls are sometimes rejected as fraudulent robocalls.

Rel. 18 of 3^{rd} Generation Partnership Project (3GPP) has created one study item related to the authenticity and authorization provided to the calling parties while using a third-party specific identity. The study item created by the Rel. 18 of 3GPP includes the below-mentioned key issues which will be studied. The Key Issue is to study the architecture impact of third-party specific user identities accessing the IMS network, including:
Study and if needed, define a mechanism illustrating how the serving IMS network can authorize a third party, and how the authorized third parties can verify whether a third-party user is allowed to use third-party specific identities to initiate a call.
Study and if needed, define a mechanism illustrating how the terminating IMS network can support the called party to verify third-party specific identities during a call.
Study whether and how IMS procedures need to be enhanced to support authentication, authorization, and verification to use third-party specific identities, which should be performed by the IMS network and the third party. This includes studying potential impacts on the call-back procedure, and potential impacts on STIR/SHAKEN procedures defined in TS 24.229[8].
Study and if needed, identify required enhancements to an IMS subscription to support trusted third parties.

TR 23.700-87 has listed the above-mentioned key issues. Thus, a mechanism needs to be provided to solve each of the key issues as explained herein.

It should be understood at the outset that although illustrative implementations of the embodiments of the present disclosure are illustrated below, the present disclosure may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “one, or more than one, or all.” Accordingly, the terms “one,” “more than one,” “more than one, but not all” or “all” would all fall under the definition of “some.” The term “some embodiments” may refer to one embodiment or to several embodiments or to all embodiments. Accordingly, the term “some embodiments” is defined as meaning “one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents.

More specifically, any terms used herein such as but not limited to “includes,” “comprises,” “has,” “have,” and grammatical variants thereof do NOT specify an exact limitation or restriction and certainly do NOT exclude the possible addition of one or more features or elements, unless otherwise stated, and must NOT be taken to exclude the possible removal of one or more of the listed features and elements, unless otherwise stated with the limiting language “must comprise” or “needs to include.”

Whether or not a certain feature or element was limited to being used only once, either way, it may still be referred to as “one or more features”, “one or more elements”, “at least one feature”, or “at least one element.” Furthermore, the use of the terms “one or more”, and “at least one” feature or element does not preclude there being none of that feature or element unless otherwise specified by limiting language such as “there needs to be one or more . . . ” or “one or more element is required.”

Unless otherwise defined, all terms, and especially any technical and/or scientific terms, used herein may be taken to have the same meaning as commonly understood by one having ordinary skill in the art.

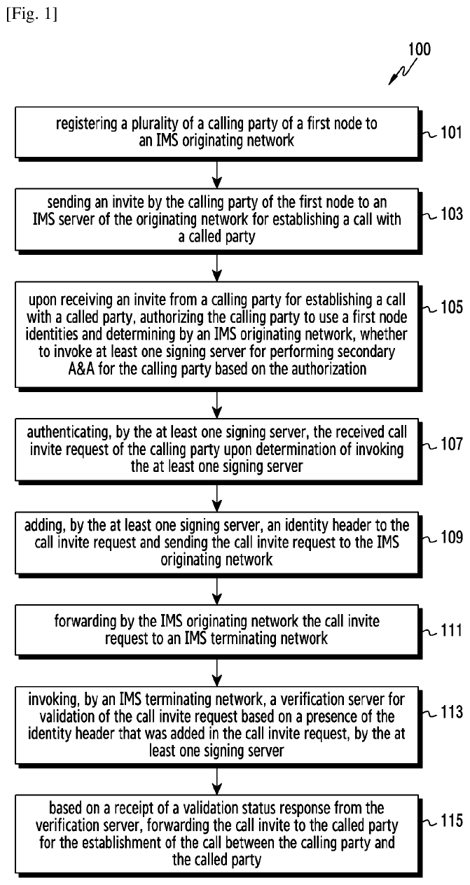

FIGS. 1 through 3, discussed below, and the various embodiments used to describe the principles of the present disclosure are by way of illustration only and should not be construed in any way to limit the scope of the disclosure. Those skilled in the art will understand that the principles of the present disclosure may be implemented in any suitably arranged system or device.

Throughout the disclosure, the expression “at least one of a, b, or c” indicates only a, only b, only c, both a and b, both a and c, both b and c, all of a, b, and c, or variations thereof.

Herein, terms to identify access nodes, terms to refer to network entities or NFs, terms to refer to messages, terms to refer to interfaces between network entities, etc., are examples for convenience of explanation. Accordingly, the disclosure is not limited to the terms as herein used and may use different terms to refer to the items having the same meaning in a technological sense.

For the convenience of explanation, the disclosure will hereinafter use terms and definitions defined by the third generation partnership project (3GPP), long-term evolution (LTE), and 5th generation (5G) standards. The disclosure is not, however, limited to the terms and definitions, and may equally apply to any systems that conform to other standards.

According to an embodiment, the present disclosure describes a method and system for authenticating and authorizing (A&A) a calling party when it uses a third-party specific identity. This ensures that the called party receives the call from an intended user. According to the present disclosure, a Home Subscriber Server (HSS) provides a parameter provisioning service by exposing a related application programming interface (API) to a node for creating group data information related to one or more calling parties of the node. Here, the node may be a third party or an application function (AF). Accordingly, after exposing the related API by the HSS, the node creates the group data information with all the necessary details like a list of IMS Public User Identity (IMPUs) that is assigned by the node for each of the plurality of calling parties, secondary authentication and authorization enable or disable information and a signing server address of the node. When one of an IMS Public User Identity (IMPU) associated with a user equipment (UE) makes a session, then the associated IMS network invokes a signing server if the corresponding IMPU is present in the group data information at an originating side IMS network. Further, a terminating side IMS network will validate through a verification server that whatever was data provided at the originating side IMS network is correct. Thereafter, successful validation of a successful session takes place. Thus, according to the present disclosure, the IMS network authentication & authorization with the help of a newly introduced signing server and the verification server makes a session based on the group data information. A detailed operation flow will be explained in the forthcoming paragraphs.

FIG. 1 illustrates a flow chart depicting a method for authenticating and authorizing a calling party by an IP Multimedia Subsystem (IMS) network, according to an embodiment of the present disclosure. FIG. 1 illustrates a method 100 performed at a network side. The method 100 may be implemented in any 3GPP system as defined by the third generation partnership project (3GPP), long-term evolution (LTE), 5th generation (5G) standards, and so on. Thus, the 3GPP system may be easily understood by a person skilled in the art.

For the convenience of explanation, the disclosure will hereinafter use terms and definitions defined by the third generation partnership project (3GPP), long-term evolution (LTE), and 5th generation (5G) standards. The disclosure is not, however, limited to the terms and definitions, and may equally apply to any systems that conform to other standards.

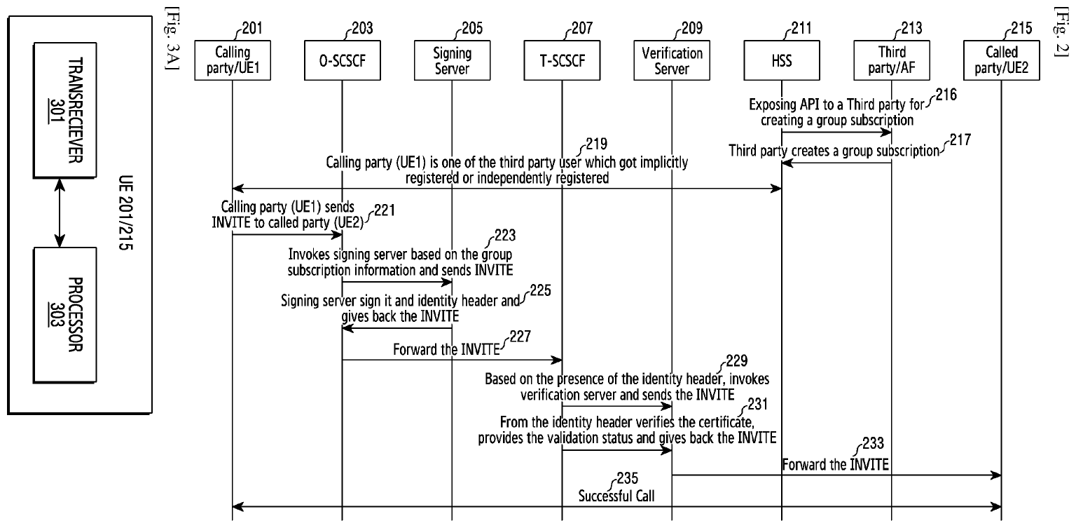

According to the step 101, the serving call session control function (S-CSCF) is configured to register one or more calling parties of the node with an IMS originating network. the node corresponds to the third party or an AF. Thus, the third party or an AF will be combinedly or separately can be referred to as the node, the third party, or the AF without deviating from the scope of the disclosure. According to an embodiment, the registration to the IMS originating network is based on IMS subscription information. Step 101 may correspond to step 219 of FIG. 2.

After the registration, at step 103, the calling parties sends an invite to an IMS server of the originating network i.e., O-SCSCF for establishing a call with a called party. As an example, here the calling parties or the called party communicates with each other using user equipment (UE). Thus, the calling parties may be alternatively referred to as UE1 and the called party may be alternatively referred to as UE2 throughout the disclosure without deviating from the scope of the disclosure. Step 103 corresponds to step 221 of FIG. 2.

Thereafter, upon receiving an invite from the calling parties for establishing the call with the called party, at step 105, the O-SCSCF authorize the calling party to use a third-party identifiers assigned by the third party and determines whether to invoke at least one signing server for performing secondary authenticating and authorizing (A&A) for the calling parties based on the authorization. The third party identifier may be alternatively referred as a first node identities or first node identifiers throughout the disclosure without deviating from the scope of the disclosure.

at step 107, the signing server authenticates the received call invite request of the calling parties 201 upon the determination of invoking the signing server.

In particular, the signing server adds, at step 109, an identity header to the call invite request and sends the call invite request including the identity header back to the O-SCSCF. The signing server adds the identity header and signs it as per the TS 24.229. According to an embodiment, the identity header includes attestation information. Further, the attestation information includes a verification certificate key. Steps 107, and 109 correspond to step 227 of FIG. 2.

Thus, after, receiving the call invite request by the O-SCSCF, the O-SCSCF at step 111 forwards the call invite request to an IMS terminating network i.e., T-SCSCF. The step 111 corresponds to the step 227 of FIG. 2. Now based on the presence of the identity header that was added in the call invite request, by the signing server, a verification server invokes, for validation of the call invite request at step 113. The step 113 corresponds to the step 229 of FIG. 2. According to the embodiment, the verification server address is configured at S-CSCFs/Interconnection Border Control Function (IBCFs). For validation, the verification server verifies the verification certificate key, and based on the verification certificate key the verification server validates the call request. Thereafter, the verification server sends a validation status response to the T-SCSCF. The validation status response indicates a successful status or an unsuccessful status. Further, the validation status response indicating the successful status represents that the received call request invite is from the authorized calling parties.

Based on the receipt of a validation status response from the verification server, the verification server forwards the call invite to the called party for the establishment of the call between the calling parties and the called party at step 115. The step 115 corresponds to step 233 of FIG. 2. Thus, the disclosed matter provides a mechanism to authorize and verify the calling parties and connect the authorized calling parties with the called party.

FIG. 2 illustrates an operational flow diagram depicting a process 200 for authenticating and authorizing a calling party by an IP Multimedia Subsystem (IMS) network, according to an embodiment of the present disclosure. For ease of understanding and brevity, the explanation of method 100 will be explained with the help of process flows 200 of FIG. 2 respectively for ease of understanding and brevity of the disclosure. Further, the reference numerals are kept the same throughout wherever applicable for ease of understanding.

According to the step 101 of FIG. 1, the serving call session control function (S-CSCF) is configured to register one or more calling parties of the node 213 with an IMS originating network. As shown in the figure the node 213 corresponds to the third party or an AF. Thus, the third party or an AF will be combinedly or separately can be referred to as the node, the third party, or the AF without deviating from the scope of the disclosure. According to an embodiment, the registration to the IMS originating network is based on IMS subscription information. Further, the registration is explained below with respect to FIG. 2.

At step 219, the calling parties is one of the third-party users which got implicitly registered or independently registered with an HSS 211. Further, before the registration occurs at step 219, a Home Subscriber Server (HSS) 211, at step 216, provides a parameter provisioning service by exposing a related application programming interface (API) to the node 213 for creating the group data information related to one or more calling parties of the node 213. Due to the exposure of the related application programming interface (API) by the HSS, the third party can create, modify or delete the group data information as part of the provisioning. The IMS originating network further shall use this group data information during an invite process which shall further be used for authentication and validation. As an example, the group data information includes a list of IMS Public User Identity (IMPUs) that is assigned by the node 213 for each of the calling parties, the secondary authentication and authorization enable or disable information, and a signing server address. The authenticating and authorizing (A&A) enable and disable information gives information on whether to enable or disable the authentication. Step 101 of FIG. 1 may correspond to step 219 of FIG. 2.

Thus, after exposing the related API at step 216, the node 213 creates the group data information by assigning the IMPUs for each of the subscribers and then generating a list of IMPUs including the IMPUs that are assigned for each of the subscribers. According to an embodiment, an authorization is done based on a presence of the IMPU of the calling party in the group data information. Thereafter, the node 213 creates the group data information, as shown in step 217, including one or more parameters that include IMS private identification (IMPI) of the calling parties, a signing server address corresponding to each of the calling parties that authenticates each of the calling parties, enables or disables information of the secondary authentication and authorization enable or disable information, and identity information of the node 213. Further, these IMPUs can be part of the same IRS (implicit registration set) or can have a subscription per IMPU as per TS 23.228. When the IMPUs are part of the same IRS then as per the existing IMS registration concept when one of the IMPUs gets registered, all other IMPUs will be implicitly registered as per TS 24.229. Hence, they can initiate the session. Thus, if a subscription is created per IMPU then each UE will be registered as per the existing IMS registration concept. Now, according to the embodiment of the present disclosure, the created group data information is provided to the HSS 211 at the step 217. The created group data information will be utilized by the IMS originating server in the further steps.

According to an embodiment, the node 213 uses directly the parameter provisioning service if the node is a trusted Application Function (AF). Further, the node 213 uses the parameter provisioning service through a Network Exposure Function (NEF) if the node 213 is an untrusted Application Function (AF).

After the registration, at step 103 of FIG. 1, the calling parties 201, sends an invite to an IMS server of the originating network i.e., O-SCSCF 203 for establishing a call with a called party 215. As an example, here the calling parties or the called party communicates with each other using user equipment (UE). Thus, the calling parties may be alternatively referred to as UE1 and the called party may be alternatively referred to as UE2 throughout the disclosure without deviating from the scope of the disclosure. Step 103 corresponds to step 221. Thereafter, upon receiving an invite from the calling parties 201 for establishing the call with the called party 251, at step 105, the O-SCSCF 203 authorize the calling party to use a third-party identifiers assigned by the third party and determines whether to invoke at least one signing server for performing secondary authenticating and authorizing (A&A) for the calling parties 201 based on the authorization. The third party identifier may be alternatively referred as a first node identities or first node identifiers throughout the disclosure without deviating from the scope of the disclosure.

According to the embodiment, the signing server 205 is newly deployed to enable authenticating and authorizing (A&A) authentication when a user initiates a session based on the group data information. Accordingly, the O-SCSCF 203 determines whether to invoke at least one signing server based on the secondary authenticating and authorizing (A&A) enable or disable information present in the group data information and an IMPU information associated with the calling parties included in the list of IMPU. In particular, the at least one signing server is invoked based on the secondary authenticating and authorizing (A&A) enable or disable information and the authorization is performed based on the presence of the IMPU of the calling party in the group data information that is provisioned by the third party.

Thereafter, if it is determined that the signing server 205 should be invoked by the O-SCSCF 203, then the O-SCSCF 203 will invoke the signing server 205 for A&A. The address of the signing server 205 is included in the group data information. The step 105 of FIG. 1 corresponds to the step 223 of the FIG. 2.

According to the embodiment, upon receiving an invite from the calling parties 201, the O-SCSCF 203 downloads the IMPU information associated with the first subscriber from the HSS 211. Thereafter, the O-SCSCF 203 determines whether the IMPU information, associated with the first subscriber, is present in the list of IMPUs included in the group data information and hence authorizing the calling party. Third party can provision a password in the group data information for the IMPUs and IMS originating network can use this password to authorize based on the password provided by the calling party. Accordingly, the signing server 205 is invoked based on a result of the determination that the first subscriber's IMPU is present in the list of IMPU's and the secondary authentication and authorization are enabled for the IMPU. Thus, the signing server 205 is invoked by invoking the signing server address corresponding to the first subscriber's IMPU that is included in the group data information.

According to the embodiment, the signing server 205 can be hosted by the third party or can be part of the IMS network. If the signing server 205 is part of the IMS network and one of the application servers (AS) can provide the functionality, then the address of the signing server can be configured in a service profile of the IMPUs which are part of the group data information and IFC can be used to invoke the signing server and the application server.

Thus, at step 107 of FIG. 1, the signing server 205 authenticates the received call invite request of the calling parties 201 upon the determination of invoking the signing server 205. In particular, the signing server 205 adds, at step 109 of FIG. 1, an identity header to the call invite request and sends the call invite request including the identity header back to the O-SCSCF 203. The signing server 205 adds the identity header and signs it as per the TS 24.229. According to an embodiment, the identity header includes attestation information. Further, the attestation information includes a verification certificate key. Steps 107, and 109 correspond to step 227 of FIG. 2. Thus, after, receiving the call invite request by the O-SCSCF 203, the O-SCSCF 203 at step 111 of FIG. 1 forwards the call invite request to an IMS terminating network i.e., T-SCSCF 207. The step 111 of FIG. 1 corresponds to the step 227. Now based on the presence of the identity header that was added in the call invite request, by the signing server 205, a verification server 209 invokes, for validation of the call invite request at step 113 of FIG. 1. The step 113 of FIG. 1 corresponds to the step 229. According to the embodiment, the verification server address is configured at S-CSCFs/Inter-connection Border Control Function (IBCFs). For validation, the verification server 209 verifies the verification certificate key, and based on the verification certificate key the verification server 209 validates the call request. Thereafter, the verification server 209 sends a validation status response to the T-SCSCF 207. The validation status response indicates a successful status or an unsuccessful status. Further, the validation status response indicating the successful status represents that the received call request invite is from the authorized calling parties. Based on the receipt of a validation status response from the verification server 209, the verification server 209 forwards the call invite to the called party 215 for the establishment of the call between the calling parties 201 and the called party 215 at step 115 of FIG. 1. The step 115 of FIG. 1 corresponds to step 233. Accordingly, at step 235 an authorized calling parties gets connected with the called party 215 as shown in step 235. Thus, the disclosed matter provides a mechanism to authorize and verify the calling parties and connect the authorized calling parties with the called party.

According to some embodiment, if the call is made between two different operators (inter-operator calls where calling and called party part of two different operators) then the operator may configure not to invoke the signing server by the S-CSCF at the originating side. The IBCF at the exit point will do it. Hence the SCSCF can provide the signing server address to the IBCF and the IBCF shall delete the signing server address before forwarding the INVITE to the terminating side. Else the IBCF can have the configuration of the signing server address per third parties. The IBCF at the exit point from the network will invoke the signing server and behave as per the TS 24.229. The IBCF at the entry point to the network will invoke the verification server and if the validation status is successful then the operator can skip the verification again at SCSCF. For the intra operator call (a call made between two users belonging to the same operator) then the operator may configure to skip the invoking of the signing server and/or verification server. Further, for the call between users of the same group (i.e., when SCSCF finds that the called party is also part of the group data information) then the operator may configure to skip the invoking of the signing server and verification server.

According to some further embodiment, O-SCSCF 203 determines whether the called party belongs to the same AF based on the group data information. Thereafter, the O-SCSCF 203, based on the determination that the called party belongs to the same AF, forwards the call invite directly from the calling parties 201 to the called party 215 for the establishment of the call between them. Thereby skipping the invocation of the signing server.

According to some further embodiment, O-SCSCF 203 determines whether the called party belongs to the same operator as the called party based on the group data information. Thereafter, the O-SCSCF 203, based on the determination that the called party belongs to the same AF, forwards the call invite directly from the calling parties 201 to the called party 215 for the establishment of the call between them. Thereby skipping the invocation of the signing server.

Accordingly, the present disclosure provides a unique mechanism implemented at the HSS for providing parameter provisioning service by exposing the related application programming interface (API) to the third party for creating the group data information with all the necessary details like list of IMPUs for which authentication and authorization is needed to use third party identities assigned by third party. The group data information is further utilized by the IMS originating network for invoking the signing server for performing secondary A&A for the calling party. The method further includes invoking a verification sever for validation of the call invite request by IMS terminating network based on the presence of identity header added by signing server. This ensures that the called party receives a call from the intended user.

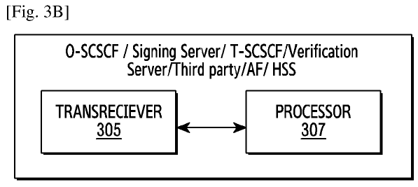

FIG. 3A illustrates a system architecture of UE according to an embodiment of the present disclosure. Referring to Figure. 3A, UE 201/205 may include a transceiver 301 and a processor 303. The transceiver 301 may operate in a communication method of the UE 201/205 as described above. Elements of UE 201/205 are not, however, limited thereto. For example, the UE 201/205 may include more (e.g., a memory) or fewer elements than described above.

The transceiver 301 may transmit or receive signals to or from another NF entity, e.g., an AMF/UDM/HSS/SMF. For signal transmission or reception to or from the other NF entity, the transceiver 301 may include an RF transmitter for up-converting the frequency of a signal to be transmitted and amplifying the signal and an RF receiver for low-noise amplifying a received signal and down-converting the frequency of the received signal. It is merely an example of the transceiver 301, and the elements of the transceiver 301 are not limited to the RF transmitter and RF receiver.

In addition, the transceiver 301 may receive a signal on a wired channel or wireless channel and output the signal to the processor 303 or transmit signal output from the processor 303 on a wired channel or wireless channel. A memory (not shown) may store a program and data required for the operation of the UE 201/205. Furthermore, the memory may store control information or data included in a signal obtained by the UE 201/205. The memory may include a storage medium such as but is not limited to a read-only memory (ROM), a random-access memory (RAM), a hard disk, a compact disc ROM (CD-ROM), and a digital versatile disc (DVD), or a combination of storage mediums.

The processor 303 may control a series of processes for the UE 201/205 to operate in accordance with the embodiments of the present disclosure. The processor 303 may include a controller or one or more processors.

FIG. 3B illustrates a system architecture of O-SCSCF/Signing Server/T-SCSCF/Verification Server/Third party/AF/HSS according to an embodiment of the present disclosure. Referring to Figure. 3B, O-SCSCF/Signing Server/T-SCSCF/Verification Server/Third party/AF/HSS may include a transceiver 305 and a processor 307. Further, the functions and the working of the transceiver 305 and a processor 307 are the same as the working of the transceiver 301 and processor 303 as explained in Figure. 3A, therefore for the sake of brevity the explanation of the same is omitted here. Further, methods 100 and 200, are implemented in the system architecture as shown in the Figure. 3B. Therefore, for the sake of brevity, the detailed operation of the same is omitted here.

In a firmware or software configuration, the method and the communication according to the embodiments of the present disclosure may be implemented in the form of modules, procedures, functions, etc. performing the above-described functions or operations. Instructions may be stored in a memory unit and executed by a processor. The memory unit may be located at the interior or exterior of the processor and may transmit and receive data to and from the processor via various known means.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

Those skilled in the art will appreciate that the operations described herein in the present disclosure may be carried out in other specific ways than those set forth herein without departing from essential characteristics of the present disclosure. The above-described embodiments are therefore to be construed in all aspects as illustrative and not restrictive. The scope of the disclosure should be determined by the appended claims, not by the above description, and all changes coming within the meaning of the appended claims are intended to be embraced therein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1-15. (canceled)

16. A method performed by a first internet protocol (IP) multimedia subsystem (IMS) network entity in a wireless communication system, the method comprising:
performing an authorization for a first user equipment (UE) to use third party identity information;
identifying whether a signing process for an intra-domain call is required based on the authorization; and
in case that the signing process for the intra-domain call is required, invoking the signing process.

17. The method of claim 16, wherein the authorization is performed based on information received from a second IMS entity, and
wherein the information includes at least one of provisioning information per IMS public user identity (IMPU) or IMPU information for the first UE.

18. The method of claim 17, wherein the first IMS network entity includes a serving call session control function (S-CSCF) entity, and
wherein the second IMS network entity includes a home subscriber server (HSS) entity.

19. The method of claim 16, wherein the authorization is performed for establishing a call between the first UE with a second UE.

20. A method performed by a second internet protocol (IP) multimedia subsystem (IMS) network entity in a wireless communication system, the method comprising:
transmitting, to a network exposure function (NEF) entity, first information requesting third party identity information;
receiving, from the NEF entity, second information associated with authorization for a first user equipment (UE); and
transmitting, to a first IMS network entity, via the first UE, the second information.

21. The method of claim 20, wherein the second information includes at least one of provisioning information per IMS public user identity (IMPU) or IMPU information for the first UE, and
wherein the authorization is performed for establishing a call between the first UE with a second UE.

22. The method of claim 20, wherein the first IMS network entity includes a serving call session control function (S-CSCF) entity, and
wherein the second IMS network entity includes a home subscriber server (HSS) entity.

23. A first internet protocol (IP) multimedia subsystem (IMS) network entity in a wireless communication system, the first IMS network entity comprising:
a transceiver, and
a controller coupled with the transceiver and configured to:
perform an authorization for a first user equipment (UE) to use third party information,
identify whether a signing process for an intra-domain call is required based on the authorization, and
in case that the signing process for the intra-domain call is required, invoke the signing process.

24. The first IMS network entity of claim 23, wherein the authorization is performed based on information received from a second IMS entity, and
wherein the information includes at least one of provisioning information per IMS public user identity (IMPU) or IMPU information for the first UE.

25. The first IMS network entity of claim 24, wherein the first IMS network entity includes a serving call session control function (S-CSCF) entity, and
wherein the second IMS network entity includes a home subscriber server (HSS) entity.

26. The first IMS network entity of claim 23, wherein the authorization is performed for establishing a call between the first UE with a second UE.

27. A second internet protocol (IP) multimedia subsystem (IMS) network entity in a wireless communication system, the second IMS network entity comprising:
a transceiver, and
a controller coupled with the transceiver and configured to:
transmit, to a network exposure function (NEF) entity, first information requesting third party identity information,
receive, from the NEF entity, second information associated with authorization for a first user equipment (UE), and
transmit, to a first IMS network entity, via the first UE, the second information.

28. The second IMS network entity of claim 27, wherein the second information includes at least one of provisioning information per IMS public user identity (IMPU) or IMPU information for the first UE, and
wherein the authorization is performed for establishing a call between the first UE with a second UE.

29. The second IMS network entity of claim 27, wherein the first IMS network entity includes a serving call session control function (S-CSCF) entity, and
wherein the second IMS network entity includes a home subscriber server (HSS) entity.
